(19) United States
(12) Patent Application Publication
(10) Pub. No.: US 2018/0007518 A1
(43) Pub. Date: Jan. 4, 2018

(54) Drone Assisted Mesh Network For First Responders

(71) Applicants: David T. O'Berry, Lexington, SC (US); Simon Hunt, Naples, FL (US)

(72) Inventors: David T. O'Berry, Lexington, SC (US); Simon Hunt, Naples, FL (US)

(21) Appl. No.: 15/201,055

(22) Filed: Jul. 1, 2016

(51) Int. Cl. H04W 4/04; G05D 1/10; H04W 4/00; B64C 39/02; H04L 29/12; H04L 29/08; H04W 36/26; H04W 84/18

(52) U.S. Cl. CPC H04W 4/046; H04L 67/12; G05D 1/104; H04W 36/26; H04W 4/008; B64C 39/024; H04L 61/2007; B64C 2201/122; H04W 84/18

(57) ABSTRACT

A flock of drones provide a drone-assisted mesh network for first responders. Network modules attached to the drones interconnect with other network modules and provide network access points for first responder devices, allowing the first responder devices to communicate with each other via the drone-assisted mesh network. The drones may autonomously reposition themselves to create a desired network coverages area, including adjusting the network coverage area as instructed via a drone controller. The network modules may communicate with a gateway to an external network, allowing first responder devices to communicate with the external network via the drone-assisted mesh network. Network modules may be selected for field-attachment to the drones based on characteristics of the first responder devices.

### TECHNICAL FIELD

Embodiments described herein generally relate to drones, and in particular, to a technique for creating a drone-assisted mesh communication network for first responders.

### BACKGROUND ART

First responders benefit from connectivity between people and systems. Voice communication, body cameras, sensors, and robotics are increasingly used to aid in management of disaster scenes. With this increased connectivity and bandwidth requirement though, the communications and data infrastructure becomes very important.

First Responders cannot always rely on correct function of regular communications infrastructure. For example, cellular networks may be compromised after an earthquake, there may be no cellular coverage in remote areas, and there may be an over-demand on cellular networks in urban areas due to public consumption after mass shootings or other urban events, overwhelming commercial networks at unpredictable times. Even if the physical infrastructure of the cellular phone network is not damaged by the disaster, traditional mobile cell towers may go down quickly in many disaster situations because of lack of electrical power.

Radio Area networks (RANs) can be valuable to first responders in the event of a disasters such as accidents or natural catastrophes, but many first responder organizations have difficulty communicating with other first responder organizations because their radio equipment operates on incompatible frequencies. Lack of reliable, cross-group communications creates problems for a site commander in addition to the problems of the disaster itself. In some situations, intermittent communication problems may be as bad if not worse than complete outages. In some situations, communications should be kept confidential from eavesdroppers.

While cellular telephone networks are valuable to first responders, in many situations, such as mass shootings, even if the physical infrastructure of the cellular phone network is not damaged, the volume of cellular phone traffic may.

While analog radios may be useful for certain types of first responder communications and may work in some coverages areas because of the low bandwidth and wavelength utilized, digital communications present additional problems. For example, as is well known to homeowners, digital signal coverage can be significantly degraded in buildings with concrete, steel, and walls of all types.

Terrestrial or land-bound digital communication options generally are insufficient in disaster settings. Satellite communications may be utilized in some disaster situations, but are expensive and may not scale for the number of individuals that are needed to handle the disaster situation. In addition, satellite phones are uncommon in the general population and not all satellite systems are compatible with each other, leading to disjointed communication infrastructures between different teams of first responders.

Having reliable, fast digital communications for voice and other technologies employed by first responders would be desirable.

### BRIEF DESCRIPTION OF DRAWINGS

FIG. 1 is a block diagram illustrating a system for providing network communications for first responders via drones according to one embodiment.

FIG. 2 is a block diagram of a drone for use in the network of FIG. 1 according to one embodiment.

FIG. 3 is a flowchart illustrating a technique for establishing and operating a drone-based first responder communication network according to one embodiment.

FIG. 4 is a block diagram illustrating a computing device for use with techniques described herein according to one embodiment.

FIG. 5 is a block diagram illustrating a computing device for use with techniques described herein according to another embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

The terms “a,” “an,” and “the” are not intended to refer to a singular entity unless explicitly so defined, but include the general class of which a specific example may be used for illustration. The use of the terms “a” or “an” may therefore mean any number that is at least one, including “one,” “one or more,” “at least one,” and “one or more than one.”

The term “or” means any of the alternatives and any combination of the alternatives, including all of the alternatives, unless the alternatives are explicitly indicated as mutually exclusive.

The phrase “at least one of” when combined with a list of items, means a single item from the list or any combination of items in the list. The phrase does not require all of the listed items unless explicitly so defined.

As used herein, the term “a computer system” can refer to a single computer or a plurality of computers working together to perform the function described as being performed on or by a computer system.

As used herein, the term “processing element” can refer to a single hardware processing element or a plurality of hardware processing elements that together may be programmed to perform the indicated actions. The hardware processing elements may be implemented as virtual hardware processing elements of a virtual programmable device hosted on a physical hardware device. Instructions that when executed program the processing element to perform an action may program any or all of the processing elements to perform the indicated action. Where the processing element is one or more multi-core processors, instructions that when executed program the processing element to perform an action may program any or all of the multiple cores to perform the indicated action.

As used herein, the term “medium” can refer to a single physical medium or a plurality of media that together store the information described as being stored on the medium.

As used herein, the term “memory” can refer to a single memory device or a plurality of memory devices that together store the information described as being stored on the medium. The memory may be any type of storage device, including random access memory, read-only memory, optical and electromechanical disk drives, etc.

As used herein, the term “drone” means an unmanned vehicle that is piloted by remote control or onboard computers. Although drones are described below in terms of flying vehicles, the term and techniques described here are not so limited, and embodiments may be used with unmanned land-based vehicles, unmanned water-based (floating) vehicles, or even unmanned spacecraft. Various embodiments described below may use drones that operate with various degrees of autonomy: either under remote control by a human operator, or fully or intermittently autonomously by onboard one or more onboard computers.

As used herein, a “Radio Area Network” (RAN) is a local area network in which packet-based communications are passed from transceiver to transceiver using radio frequency (RF) transmission, typically at frequencies other than used by Wi-Fi networks. One example of a RAN is one that employs portable mobile cellular sites, sometimes called “cell on wheels,” that can provide temporary network and wireless coverage to locations where cellular coverage is minimal or compromised. Another example of a RAN is one that uses radio transceivers that allow first responders to use portable radios for communicating with other first responders in emergency situations.

As used herein, the term “mesh network” means a network topology in which each node relays data for the network. All mesh nodes cooperate in the distribution of data in the network. In the context of the description below, the nodes of the mesh network are drones. A mesh network need not be a fully-connected mesh network in which all nodes are directly interconnected, but encompasses a network in which some nodes are connected to a subset of the other nodes of the network.

As used herein, the term “flock of drones” refers to a plurality of drones that together provide network coverage for a drone-assisted mesh network.

As used herein, the term “first responder” refers to those individuals who in the early stages of an incident are responsible for the protection and preservation of life, property, evidence, and the environment, including emergency response providers as defined in section 2 of the Homeland Security Act of 2002 (6 U.S.C. §101), as well as emergency management, public health, clinical care, public works, and other skilled support personnel (such as equipment operators) that provide immediate support services during prevention, response, and recovery operations. Emergency response providers as defined by 6 U.S.C. §101 include Federal, State, and local governmental and nongovernmental emergency public safety, fire, law enforcement, emergency response, emergency medical (including hospital emergency facilities), and related personnel, agencies, and authorities.

Although the description below is written in terms of first responders, the same techniques could be used for other groups, including the military.

In the description below, we propose leveraging the combination of one or more automated drones, which support auto-navigation and collision avoidance, carrying standard Wi-Fi® data communications technology (hotspots) (WI-FI is a registered trademark of Wi-Fi Alliance), and additionally manually placed transceivers, to create a “flock” or “herd” coverage of a bounded area to allow first responder technology such as voice-over-data, IP cameras, sensors, and remote control using commodity Wi-Fi components, creating a redundant self-healing data network. However, embodiments may use other than Wi-Fi standards for radio communication as desired.

The drones may be deployed autonomously or manually across the disaster site area to create a redundant meshed data network, which may also provide analog radio communications capability (backhaul over data). The network may have the option to self-deploy (a flock or herd effect), self-heal on an outage of a node, and leverage algorithms to balance transceivers based on loading. Thus, a robust, reliable, temporary data network may be achieved without the requirement for proprietary and expensive communications hardware common to each division of first responders. Any low-cost commodity Wi-Fi-capable device can be used, eliminating the current dependency on regular cellular infrastructure or proprietary short-range radio systems.

The network may have any or all of the following characteristics:

Self-Healing mobile ad hoc network (MANET), using protocols such as OrderOne Manet Routing Protocol (OORP), Optimized Link State Routing (OLSR), IEEE 802.11s, etc.;

Automated geographic distribution of transceivers, using unmanned air vehicle (UAV) navigation techniques;

Automatic replacement of failed transceivers;

Spread Spectrum IP Networks using every node (not just the drones) as reflectors; and

Support for land based, flying (and landing), and manually placed transceivers.

The data network may be used by any first responder device, using authentication such as Extensible Authentication Protocol-Transport Layer Security (EAP-TLS) or other standard protocols (so as not to require passwords).

Embodiments described below are intersections of many emerging standards to achieve the goal of a temporary, self-deploying robust data network.

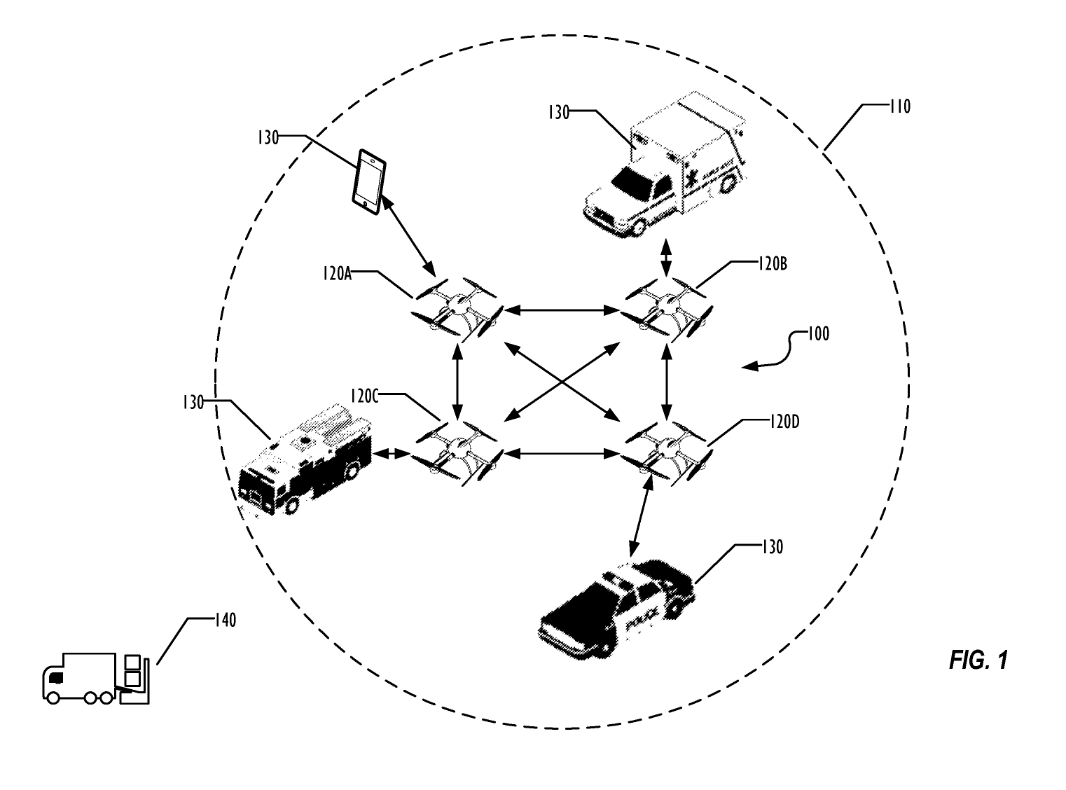

FIG. 1 is a block diagram of a network 100 of drones 120A-120D connected in a mesh network to provide Wi-Fi coverage in an area 110. Although illustrated for simplicity in FIG. 1 as a circular area, the coverage area 110 may have any desired shape, and is typically shaped based on the actual deployment of the drones as well as environmental conditions. Although shown as a contiguous area 110, in some scenarios, the coverage area may be a collection of disconnected coverage areas and may have holes or gaps in the coverage area within the perimeter of the coverage area 110. For example, a lake surrounded by drones on all sides might provide Wi-Fi coverage surrounding the lake, even though a portion of the middle of the lake might have no coverage.

Although four drones 120A-120D are illustrated in FIG. 1, any number (including one) may be used as needed or desired, although typically a plurality of drones are used. The network 100 is illustrated as a fully interconnected mesh network. However, embodiments may employ any level of interconnectivity of the drones. While multiple disconnected drone networks 100 may be used in some situations, in general a single interconnected network 100 is preferred, even if some drones 120 are only connected to one adjacent drone 120 in the network.

As illustrated in FIG. 1, the network of drones 100 provides Wi-Fi network coverage to any number of devices within the coverage area 110. Whether first responders 130 are law enforcement officials, fire departments, emergency medical technicians, or any other type of first responder having a wireless device capable of communicating wirelessly with the drone network 100, any first responder 130 within the coverage area 110 would be able to communicate with any other first responder 130 within the coverage area 110.

In one embodiment, a first responder network provider would maintain a mobile unit 140 containing a suitable number of drones 120. Upon notice of a disaster site needing drone network support, the mobile unit may be transported to site. The mobile unit 140 is then unpacked and a flock of drones 120 launched to form the drone-based network. The drone operator may determine based on the environmental conditions, the number of first responders, and where those first responders are expected to be deployed to determine the shape of the coverage area 110 and where the drones 120 should be deployed. As the situation changes, the shape of the coverage area 110 may change and the drones 120 may automatically reposition themselves to achieve network coverages in the changed area 110.

Because drones are battery powered, their flight time is limited. Preferably, the flock of drones 120 are deployed with redundancy so that a drone 120 can be withdrawn from service for recharging or because of a malfunction without leaving a significant portion of the coverage area without coverage. This may involve holding back drones 120 from the initial launch of the flock of drones 120, where the held back drone 120 can be launched to take the place of a drone 120 that is about to be or has been withdrawn from service. In some embodiments, the mobile unit 140 may provide a drone repair facility for onsite repair, as well as a recharging station, which may be generator driven. Upon completion of operations at the disaster site, the flock of drones 120 may be recalled to the mobile unit 140 and packed away for the next disaster.

The network 100 and drones 120 thus provide relatively low-cost Wi-Fi coverage for allowing first responders to communicate with each other, even where the normal radio equipment of different groups of first responders might make communication between those groups difficult.

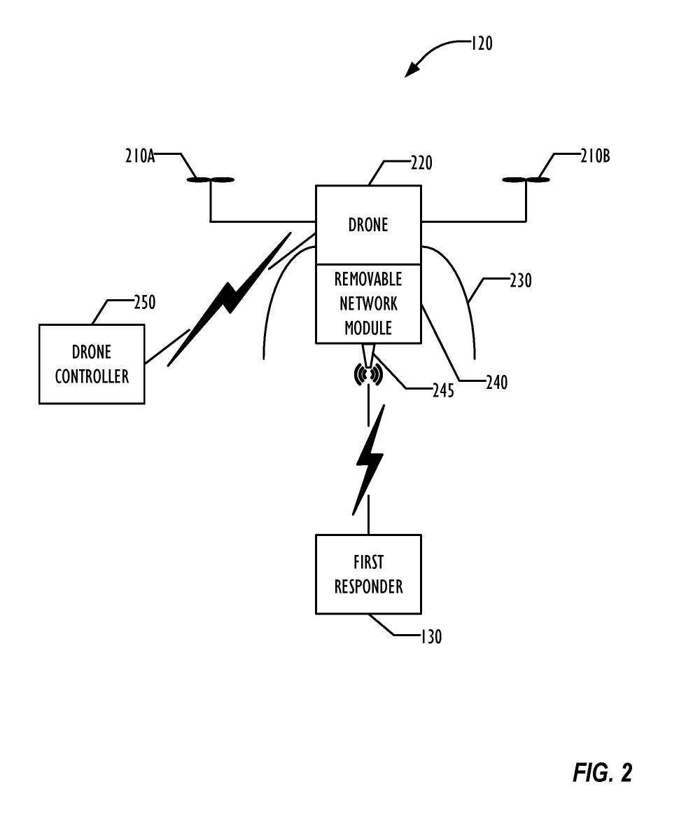

FIG. 2 is a block diagram of a drone 120 according to one embodiment. The drone 120 may be a commercially available drone from any vendor that is capable of mounting a network module 240 to the body 220 of the drone 120. As illustrated in FIG. 2, the drone 120 uses two propellers 210A and 210B for lift and propulsion, but typically four or more propellers are used for stability and for recovery should one of the propellers malfunction for any reason or be damaged, such as from debris. Any number of legs 230 may be provided to give the drone 120 a stable landing configuration. As is known in the art, features of various configurations may be included to protect the propellers 210 as desired, such as circular or arcuate features about part or all of the rotation area of the propellers.

A drone controller 250 may be used to provide remote control or to send commands to the drone 120, such as for positioning the drone 120 in the air or instructing the drone 120 to take off or land. In addition, the drone controller, typically a computer, may be used for recharging the drone 120. In one embodiment, the drone controller 250 contains software that when executed programs the drone controller 250 to define the area of coverage 110 that the drone network 100 should support. In one embodiment, an operator may define the area of coverage, such as by drawing an outline on a map, while the drone network 100 automatically positions the drones 120 to achieve the desired coverages area. The drone controller 250 in some embodiments may be mounted in the mobile unit 140 that provides transport for the drones 120.

A removable network module 240 is attached to the body 220 of the drone 120 to provide network coverage. The network module 240 may comprise an antenna 245 for wireless communication with the first responders 130 and with the other network modules 240 of the network 100. Alternately, the network module may connect to an antenna provided by the drone 120. Different network modules 240 may be used depending on the known type of devices to be used by the first responders 130. For example, a network module 240 that is optimized for backhauling analog radio data may be used for first responders 130 that may use only or mostly analog radios. In another example, a network module 240 that is optimized for Wi-Fi traffic may be used if Wi-Fi devices are the predominant type of devices that are to be used. Each of the network modules 240 may serve as Wi-Fi or other types of network access points, allowing wireless devices in range of the transceiver of the network module 240 to connect to the network 100. In addition, the network modules 240 may route traffic among the other network modules 240, allowing first responders 130 to communicate with other first responders 130 across the coverage area 110 regardless of which network module 240 provides network access to each first responder 130. Because the network modules 240 are removable modules, the mobile unit 140 may carry multiple types of network modules 240, allowing selection of the network module or modules 240 that are mounted on the drone 120 as needed for the particular situation.

The network module 240 may be attached to the body 220 of the drone 120 in any desired manner, including screws, clips, etc. Preferably, the network module 240 is removably attachable to the body 220, so that it may be field-attached to the body 220 before launching the drone 120.

In some embodiments, the network module 240 can control movement of the drone 120 to which the network module 240 is attached, allowing the network module to reposition the drone 120 as desired to maintain network coverage.

Additional modules may be configured for attachment to the drone 120. For example, if the drone 120 is not natively configured for a camera mounting, a camera module (not shown in FIG. 2) may also be mounted to the drone 120. The camera of the camera module, being IP connected, could then be used by any or all of the first responders 130 connected to the network. Multiple network modules 240 may be mounted on the drone 120 if desired to allow communication with different classes of network devices. Each network module 240 is a programmable device that is configured or programmed to perform the networking functionality. Functionality other than networking may be provided by the network module 240 as desired.

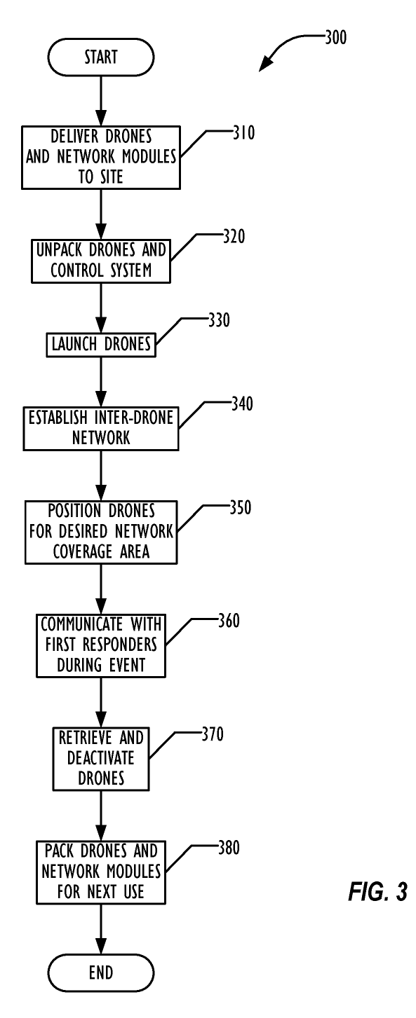

FIG. 3 is a flowchart 300 that illustrates a technique for providing the drone-based network 100 according to one embodiment. In block 310, the mobile unit 140 transports the drones 120 to the disaster site. In block 320, the flock of drones 120 is unpacked, along with the controller 250. The desired network modules 240 are selected and mounted on the drones 120.

In block 330, the drones 120 are activated and may be launched. In one embodiment, the drones 120 are configured to auto-launch as soon as they are activated. In other embodiments, the drones 120 are launched under control of the controller 250.

In block 340, the drones 120, and in particular the network modules 240 mounted on the drones, establish the drone network 100, making network connections between the drones 120. Preferably, the drone network 100 is configured as a self-healing MANET, using a mesh network routing protocol. MANETs are a kind of wireless ad hoc network with a routable networking environment on top of a link layer ad hoc network. MANETs typically comprise peer-to-peer, self-healing networks. Each drone 120 in the network 100 is free to move independently in any direction, and may change its links to other devices in the network frequently. Embodiments may use various types of ad hoc network routing protocols, including table-driven routing, on-demand routing, hybrid routing, and hierarchical routing. Examples of a proactive table-driven routing protocol include OLSR, Babel, Destination Sequence Distance Vector, and Distance Routing Effect Algorithm for Mobility. Examples of a reactive on-demand routing protocol include ad hoc on-demand distance vector, dynamic source routing (DSR), flow state in DSR, and power-aware DSR. Examples of both proactive and reactive hybrid routing protocols include Zone Routing Protocol, and Zone-based Hierarchical Link State Routing Protocol. Examples of hierarchical routing protocols include OORP from OrderOne Networks, Cluster Based Routing Protocol, and Fisheye State Routing Protocol. In some embodiments, the network modules 240 support IEEE 802.11s, an IEEE 802.11 amendment for mesh networking, using Hybrid Wireless Mesh Protocol, other mesh, ad hoc, or dynamically link-state routed protocols, or even static routing. These example protocols are illustrative and by way of example only, and other ad hoc network routing protocols may be used as desired.

First responder networks may carry information that should not be made available to the general public or should be limited to the first responders 130. Therefore, in some embodiments, authentication techniques may be included in the network modules 240, insuring that only network modules of the flock of drones 120 and authenticated users of the drone network 100 are allowed to communicate across the drone network 100. Examples of such authentication techniques include EAP-TLS and IEEE 802.11u, but any desired authentication technique may be used. Similarly, encryption may be used to protect network transmissions across the drone network 100 and between the first responders 130, using any desired encryption technique.

In block 360, once the drone network 100 has been established, first responders 130 communicate with drones 120 and thus each other via the drone network 100. In some embodiments, one or more of the drones 120 or another unit, such as the controller 250 may provide a gateway to the Internet or other external networks for additional capability. For example, in one embodiment, one or more of the drones 120 or the control unit may be a gateway into an existing telephone network, including a cellular network, allowing first responders to make telephone calls across the drone network 100, even when out of range of a cellular tower. Once the response by first responders to the disaster or other situation requiring the drone network 100 has ended, the flock of drones 120 may be retrieved and deactivated in block 370. In block 380, the network modules 240 may be removed or left connected to the drones 120 as desired, and the flock of drones 120 repacked for the next event requiring drone-based networking.

Although the drones 120 are designed for flight, the network routing module 240 may be configured in some embodiments to provide networking even if the drone 120 has landed. Thus, in some circumstances, the drones 120 may be launched, fly to their desired positions, then land and perform network routing functions while on the ground. In some embodiments, the network module 240 may be a self-contained module that can be delivered by the drone 120 to a desired location, dropped off for operation during the first responder event, and then retrieved by a drone 120.

In block 350 the drones 120 are positioned. In some embodiments, the drones 120 may automatically position themselves using autonomous navigation techniques. For example, the drones 120 may automatically perform station-keeping techniques to keep them at certain distances from other drones 120 or position the drones based on signal strength to provide the desired Wi-Fi network coverage area. Alternately, the controller 250 may be programmed to direct the drones to fly to desired positions, at least initially, based on the desired coverage area 110. In some embodiments, the drones 120 may be programmed to automatically return to the controller 250 after a certain time to recharge, then be re-launched to augment the network 100.

In one embodiment, the controller 250 may keep some of the flock of drones 120 in reserve initially, so that when a drone is taken out of service, the controller 250 may launch a reserve drone 120, either automatically or under manual control of an operator.

In some embodiments, the network modules 240 use spread spectrum techniques to establish secure communications with the other network modules 240, increasing resistance to natural interference, noise, and jamming.

The ordering of blocks in the flowchart 300 is illustrative and by way of example only, and other orderings of blocks may be used. Although illustrated as sequential actions in FIG. 3 for clarity, some of the actions of the technique may be performed in parallel. Similarly, embodiments may combine blocks that are illustrated in FIG. 3 as separate, or may separate actions that are illustrated in FIG. 3 as a single block into multiple blocks of actions as desired. In addition, some embodiments may include additional actions not illustrated in FIG. 3 or may omit certain actions illustrated in FIG. 3 as appropriate for the intended use.

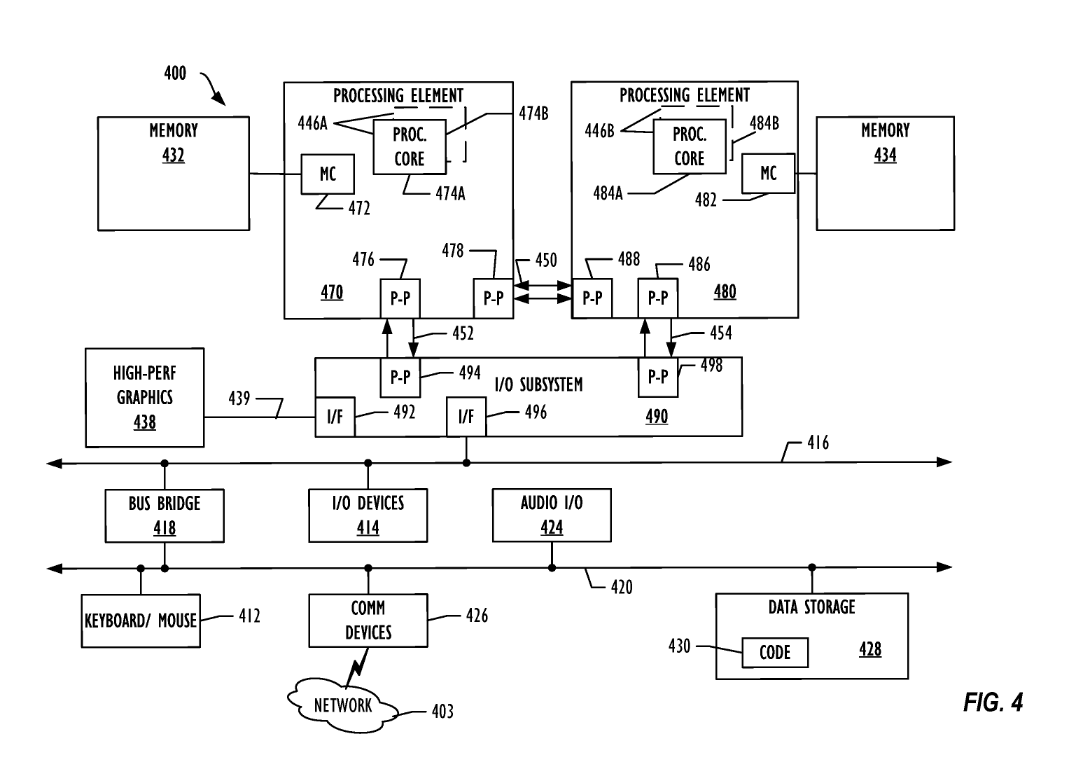

Referring now to FIG. 4, a block diagram illustrates a programmable device 400 that may be used for implementing the techniques described herein in accordance with one embodiment. The programmable device 400 illustrated in FIG. 4 is a multiprocessor programmable device that includes a first processing element 470 and a second processing element 480. While two processing elements 470 and 480 are shown, an embodiment of programmable device 400 may also include only one such processing element.

Programmable device 400 is illustrated as a point-to-point interconnect system, in which the first processing element 470 and second processing element 480 are coupled via a point-to-point interconnect 450. Any or all of the interconnects illustrated in FIG. 4 may be implemented as a multi-drop bus rather than point-to-point interconnects.

As illustrated in FIG. 4, each of processing elements 470 and 480 may be multicore processors, including first and second processor cores (i.e., processor cores 474a and 474b and processor cores 484a and 484b). Such cores 474a, 474b, 484a, 484b may be configured to execute instruction code. However, other embodiments may use processing elements that are single core processors as desired. In embodiments with multiple processing elements 470, 480, each processing element may be implemented with different numbers of cores as desired.

Each processing element 470, 480 may include at least one shared cache 446. The shared cache 446a, 446b may store data (e.g., instructions) that are utilized by one or more components of the processing element, such as the cores 474a, 474b and 484a, 484b, respectively. For example, the shared cache may locally cache data stored in a memory 432, 434 for faster access by components of the processing elements 470, 480. In one or more embodiments, the shared cache 446a, 446b may include one or more mid-level caches, such as level 2 (L2), level 3 (L3), level 4 (L4), or other levels of cache, a last level cache (LLC), or combinations thereof.

While FIG. 4 illustrates a programmable device with two processing elements 470, 480 for clarity of the drawing, the scope of the present invention is not so limited and any number of processing elements may be present. Alternatively, one or more of processing elements 470, 480 may be an element other than a processor, such as an graphics processing unit (GPU), a digital signal processing (DSP) unit, a field programmable gate array, or any other programmable processing element. Processing element 480 may be heterogeneous or asymmetric to processing element 470. There may be a variety of differences between processing elements 470, 480 in terms of a spectrum of metrics of merit including architectural, microarchitectural, thermal, power consumption characteristics, and the like. These differences may effectively manifest themselves as asymmetry and heterogeneity amongst processing elements 470, 480. In some embodiments, the various processing elements 470, 480 may reside in the same die package.

First processing element 470 may further include memory controller logic (MC) 472 and point-to-point (P-P) interconnects 476 and 478. Similarly, second processing element 480 may include a MC 482 and P-P interconnects 486 and 488. As illustrated in FIG. 4, MCs 472 and 482 couple processing elements 470, 480 to respective memories, namely a memory 432 and a memory 434, which may be portions of main memory locally attached to the respective processors. While MC logic 472 and 482 is illustrated as integrated into processing elements 470, 480, in some embodiments the memory controller logic may be discrete logic outside processing elements 470, 480 rather than integrated therein.

Processing element 470 and processing element 480 may be coupled to an I/O subsystem 490 via respective P-P interconnects 476 and 486 through links 452 and 454. As illustrated in FIG. 4, I/O subsystem 490 includes P-P interconnects 494 and 498. Furthermore, I/O subsystem 490 includes an interface 492 to couple I/O subsystem 490 with a high performance graphics engine 438. In one embodiment, a bus (not shown) may be used to couple graphics engine 438 to I/O subsystem 490. Alternately, a point-to-point interconnect 439 may couple these components.

In turn, I/O subsystem 490 may be coupled to a first link 416 via an interface 496. In one embodiment, first link 416 may be a Peripheral Component Interconnect (PCI) bus, or a bus such as a PCI Express bus or another I/O interconnect bus, although the scope of the present invention is not so limited.

As illustrated in FIG. 4, various I/O devices 414, 424 may be coupled to first link 416, along with a bridge 418 that may couple first link 416 to a second link 420. In one embodiment, second link 420 may be a low pin count (LPC) bus. Various devices may be coupled to second link 420 including, for example, a keyboard/mouse 412, communication device(s) 426 (which may in turn be in communication with the computer network 403), and a data storage unit 428 such as a disk drive or other mass storage device which may include code 430, in one embodiment. The code 430 may include instructions for performing embodiments of one or more of the techniques described above. Further, an audio I/O 424 may be coupled to second link 420.

Note that other embodiments are contemplated. For example, instead of the point-to-point architecture of FIG. 4, a system may implement a multi-drop bus or another such communication topology. Although links 416 and 420 are illustrated as busses in FIG. 4, any desired type of link may be used. In addition, the elements of FIG. 4 may alternatively be partitioned using more or fewer integrated chips than illustrated in FIG. 4.

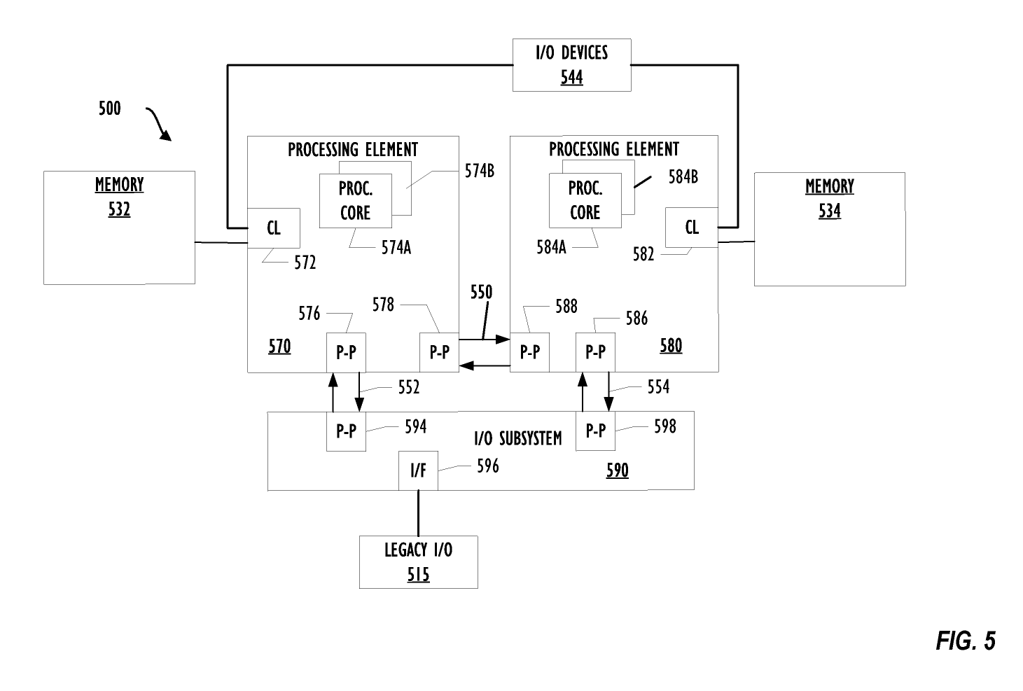

Referring now to FIG. 5, a block diagram illustrates a programmable device 500 according to another embodiment. Certain aspects of FIG. 5 have been omitted from FIG. 5 in order to avoid obscuring other aspects of FIG. 5.

FIG. 5 illustrates that processing elements 570, 580 may include integrated memory and I/O control logic (“CL”) 572 and 582, respectively. In some embodiments, the 572, 582 may include memory control logic (MC) such as that described above in connection with FIG. 4. In addition, CL 572, 582 may also include I/O control logic. FIG. 5 illustrates that not only may the memories 532, 534 be coupled to the CL 572, 582, but also that I/O devices 544 may also be coupled to the control logic 572, 582. Legacy I/O devices 515 may be coupled to the I/O subsystem 590 by interface 596. Each processing element 570, 580 may include multiple processor cores, illustrated in FIG. 5 as processor cores 574A, 574B, 584A and 584B. As illustrated in FIG. 5, I/O subsystem 590 includes point-to-point (P-P) interconnects 594 and 598 that connect to P-P interconnects 576 and 586 of the processing elements 570 and 580 with links 552 and 554. Processing elements 570 and 580 may also be interconnected by link 550 and interconnects 578 and 588, respectively.

The programmable devices depicted in FIGS. 4 and 5 are schematic illustrations of embodiments of programmable devices that may be utilized to implement various embodiments discussed herein. Various components of the programmable devices depicted in FIGS. 4 and 5 may be combined in a system-on-a-chip (SoC) architecture.

Referring now to FIG. 4, a block diagram illustrates a programmable device 400 that may be used for implementing the techniques described herein in accordance with one embodiment. The programmable device 400 illustrated in FIG. 4 is a multiprocessor programmable device that includes a first processing element 470 and a second processing element 480. While two processing elements 470 and 480 are shown, an embodiment of programmable device 400 may also include only one such processing element.

Programmable device 400 is illustrated as a point-to-point interconnect system, in which the first processing element 470 and second processing element 480 are coupled via a point-to-point interconnect 450. Any or all of the interconnects illustrated in FIG. 4 may be implemented as a multi-drop bus rather than point-to-point interconnects.

As illustrated in FIG. 4, each of processing elements 470 and 480 may be multicore processors, including first and second processor cores (i.e., processor cores 474a and 474b and processor cores 484a and 484b). Such cores 474a, 474b, 484a, 484b may be configured to execute instruction code. However, other embodiments may use processing elements that are single core processors as desired. In embodiments with multiple processing elements 470, 480, each processing element may be implemented with different numbers of cores as desired.

Each processing element 470, 480 may include at least one shared cache 446. The shared cache 446a, 446b may store data (e.g., instructions) that are utilized by one or more components of the processing element, such as the cores 474a, 474b and 484a, 484b, respectively. For example, the shared cache may locally cache data stored in a memory 432, 434 for faster access by components of the processing elements 470, 480. In one or more embodiments, the shared cache 446a, 446b may include one or more mid-level caches, such as level 2 (L2), level 3 (L3), level 4 (L4), or other levels of cache, a last level cache (LLC), or combinations thereof.

While FIG. 4 illustrates a programmable device with two processing elements 470, 480 for clarity of the drawing, the scope of the present invention is not so limited and any number of processing elements may be present. Alternatively, one or more of processing elements 470, 480 may be an element other than a processor, such as an graphics processing unit (GPU), a digital signal processing (DSP) unit, a field programmable gate array, or any other programmable processing element. Processing element 480 may be heterogeneous or asymmetric to processing element 470. There may be a variety of differences between processing elements 470, 480 in terms of a spectrum of metrics of merit including architectural, microarchitectural, thermal, power consumption characteristics, and the like. These differences may effectively manifest themselves as asymmetry and heterogeneity amongst processing elements 470, 480. In some embodiments, the various processing elements 470, 480 may reside in the same die package.

First processing element 470 may further include memory controller logic (MC) 472 and point-to-point (P-P) interconnects 476 and 478. Similarly, second processing element 480 may include a MC 482 and P-P interconnects 486 and 488. As illustrated in FIG. 4, MCs 472 and 482 couple processing elements 470, 480 to respective memories, namely a memory 432 and a memory 434, which may be portions of main memory locally attached to the respective processors. While MC logic 472 and 482 is illustrated as integrated into processing elements 470, 480, in some embodiments the memory controller logic may be discrete logic outside processing elements 470, 480 rather than integrated therein.

Processing element 470 and processing element 480 may be coupled to an I/O subsystem 490 via respective P-P interconnects 476 and 486 through links 452 and 454. As illustrated in FIG. 4, I/O subsystem 490 includes P-P interconnects 494 and 498. Furthermore, I/O subsystem 490 includes an interface 492 to couple I/O subsystem 490 with a high performance graphics engine 438. In one embodiment, a bus (not shown) may be used to couple graphics engine 438 to I/O subsystem 490. Alternately, a point-to-point interconnect 439 may couple these components.

In turn, I/O subsystem 490 may be coupled to a first link 416 via an interface 496. In one embodiment, first link 416 may be a Peripheral Component Interconnect (PCI) bus, or a bus such as a PCI Express bus or another I/O interconnect bus, although the scope of the present invention is not so limited.

As illustrated in FIG. 4, various I/O devices 414, 424 may be coupled to first link 416, along with a bridge 418 that may couple first link 416 to a second link 420. In one embodiment, second link 420 may be a low pin count (LPC) bus. Various devices may be coupled to second link 420 including, for example, a keyboard/mouse 412, communication device(s) 426 (which may in turn be in communication with the computer network 403), and a data storage unit 428 such as a disk drive or other mass storage device which may include code 430, in one embodiment. The code 430 may include instructions for performing embodiments of one or more of the techniques described above. Further, an audio I/O 424 may be coupled to second link 420.

Note that other embodiments are contemplated. For example, instead of the point-to-point architecture of FIG. 4, a system may implement a multi-drop bus or another such communication topology. Although links 416 and 420 are illustrated as busses in FIG. 4, any desired type of link may be used. In addition, the elements of FIG. 4 may alternatively be partitioned using more or fewer integrated chips than illustrated in FIG. 4.

Referring now to FIG. 5, a block diagram illustrates a programmable device 500 according to another embodiment. Certain aspects of FIG. 5 have been omitted from FIG. 5 in order to avoid obscuring other aspects of FIG. 5.

FIG. 5 illustrates that processing elements 570, 580 may include integrated memory and I/O control logic (“CL”) 572 and 582, respectively. In some embodiments, the 572, 582 may include memory control logic (MC) such as that described above in connection with FIG. 4. In addition, CL 572, 582 may also include I/O control logic. FIG. 5 illustrates that not only may the memories 532, 534 be coupled to the CL 572, 582, but also that I/O devices 544 may also be coupled to the control logic 572, 582. Legacy I/O devices 515 may be coupled to the I/O subsystem 590 by interface 596. Each processing element 570, 580 may include multiple processor cores, illustrated in FIG. 5 as processor cores 574A, 574B, 584A and 584B. As illustrated in FIG. 5, I/O subsystem 590 includes point-to-point (P-P) interconnects 594 and 598 that connect to P-P interconnects 576 and 586 of the processing elements 570 and 580 with links 552 and 554. Processing elements 570 and 580 may also be interconnected by link 550 and interconnects 578 and 588, respectively.

The programmable devices depicted in FIGS. 4 and 5 are schematic illustrations of embodiments of programmable devices that may be utilized to implement various embodiments discussed herein. Various components of the programmable devices depicted in FIGS. 4 and 5 may be combined in a system-on-a-chip (SoC) architecture.

Embodiments may be implemented in one or a combination of hardware, firmware, and software. Embodiments may also be implemented as instructions stored on a computer-readable storage medium, which may be read and executed by at least one processing element to perform the operations described herein. A computer-readable storage medium may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

Embodiments, as described herein, may include, or may operate on, logic or a number of components, modules, or mechanisms. Modules may be hardware, software, or firmware communicatively coupled to one or more processing elements in order to carry out the operations described herein. Modules may be hardware modules, and as such, modules may be considered tangible entities capable of performing specified operations and may be configured or arranged in a certain manner. Circuits may be arranged (e.g., internally or with respect to external entities such as other circuits) in a specified manner as a module. The whole or part of one or more programmable devices (e.g., a standalone client or server computer system) or one or more hardware processing elements may be configured by firmware or software (e.g., instructions, an application portion, or an application) as a module that operates to perform specified operations. The software may reside on a computer readable medium. The software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Where modules are temporarily configured, each of the modules need not be instantiated at any one moment in time. For example, where the modules comprise a general-purpose hardware processing element configured using software; the general-purpose hardware processing element may be configured as respective different modules at different times. Software may accordingly program a hardware processor, for example, to constitute a particular module at one instance of time and to constitute a different module at a different instance of time. Modules may also be software or firmware modules, which operate to perform the methodologies described herein.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

1. A drone-assisted mesh network, comprising:
a plurality of drones;
a plurality of network modules, attached to the plurality of drones,
wherein in operation the plurality of network modules form a wireless mesh network,
wherein the plurality of network modules comprise network access points for first responders, and provide communication between users via the meshed network.

2. The drone-assisted mesh network of claim 1, wherein the plurality of drones are programmed to position themselves to provide network coverage over a predetermined area.

3. The drone-assisted mesh network of claim 2, wherein the plurality of drones are programmed to automatically position themselves to provide network coverage over the predetermined area.

4. The drone-assisted mesh network of claim 1, further comprising:
a gateway node, programmed to provide a gateway between the plurality of drones and an external network.

5. The drone-assisted mesh network of claim 1, further comprising:
a controller, programmed to instruct the plurality of drones to position themselves to provide network coverage to a predetermined area.

6. The drone-assisted mesh network of claim 1, wherein the wireless mesh network is a self-healing wireless mesh network.

7. The drone-assisted mesh network of claim 1, wherein the plurality of network modules are removably attached to the plurality of drones.

8. The drone-assisted mesh network of claim 1, wherein the plurality of network modules are selected based on information about devices used by the first responders.

9. A method of providing a drone-assisted mesh network, comprising:
attaching a plurality of network modules to a plurality of drones;
launching the plurality of drones;
positioning the plurality of drones based on a desired network coverage area;
forming a wireless mesh network with the plurality of network modules; and
communicating between user devices via the wireless mesh network.

10. The method of claim 9, comprising: selecting the plurality of network modules based on the user devices.

11. The method of claim 9, wherein attaching a plurality of network modules comprises removably attaching the plurality of network modules to the plurality of drones.

12. The method of claim 9, wherein positioning the plurality of drones comprises:
positioning the plurality of drones autonomously.

13. The method of claim 9, wherein positioning the drones comprises:
moving each of the plurality of drones to an initial position; and
adjusting a position of at least some of the drones because of a change in the desired network coverage area.

14. The method of claim 9, further comprising:
gatewaying between the drone-assisted mesh network and an external network.

15. The method of claim 14, wherein the external network is a cellular telephone network.

16. The method of claim 14, further comprising:
authenticating the first responder devices to the drone-assisted mesh network.

17. A network module for creating a drone-assisted mesh network for first responders, comprising:
a processing element;
a memory coupled to the processing element, on which is stored instructions that when executed program the processing element to:
make inter-connections with other drone-attached network modules, forming the drone-assisted mesh network for first responders;
reposition a drone to which the network module is attached to maintain coverage of the drone-assisted mesh network across a predetermined coverage area; and
provide a network access point for first responder devices, allowing the first responder devices to communicate with other first responder devices via the network module.

18. The network module of claim 17, wherein the instructions further comprise instructions that when executed program the processing element to:
authenticate the first responder devices to the drone-assisted mesh network.

19. The network module of claim 17, wherein the network module is removably attachable to a body of a drone.

20. The network module of claim 17, wherein the instructions that when executed program the processing element to reposition the drone comprise instructions that when executed program the network module to reposition the drone autonomously to maintain coverage of the drone-assisted mesh network across the predetermined coverage area.

21. The network module of claim 17, wherein instructions further comprise instructions that when executed program the processing element to make a network connection between the drone-assisted mesh network to an external network via a gateway.

22. The network module of claim 17, wherein instructions further comprise instructions that when executed program the processing element to communicate with a drone controller.

23. The network module of claim 22, wherein the instructions that when executed program the processing element to communicate with the drone controller comprise instructions that when executed cause the network module to receive positioning instructions from the drone controller.

24. The network module of claim 17, further comprising an antenna, coupled to the processing element, wherein the processing element communicates to the first responder devices and other network modules via the antenna.

25. The network module of claim 17, wherein the drone-assisted mesh network is a self-healing mobile ad hoc network.
